(19) United States
(12) Patent Application Publication
(10) Pub. No.: US 2007/0065549 A1
(43) Pub. Date: Mar. 22, 2007

(54) Method and system for producing animal feed

(75) Inventor: Ray Hinderliter, Wichita, KS (US)

Correspondence Address: HOVEY WILLIAMS LLP, 2405 GRAND BLVD., SUITE 400, KANSAS CITY, MO, 64108, US

(73) Assignee: Pellet Products

(21) Appl. No.: 11/230,717

(22) Filed: Sep. 20, 2005

(51) Int. Cl. A23B 4/005

(52) U.S. Cl. 426/511

(57) ABSTRACT

A method for producing animal feed comprises the steps of introducing water into a boiler; boiling the water to create steam; collecting the steam and directing it out of the boiler; injecting a moisturizer into the steam after the steam has exited the boiler to create a steam/moisturizer mixture; feeding grains into a steam chest; applying the steam/moisturizer mixture to the grains in the steam chest to create a grain mixture; and forming the grain mixture into animal feed pieces of a desired shape and size. By injecting the moisturizer into the steam after the steam has exited the boiler instead of mixing the conditioner with water introduced into the boiler, none of the moisturizer is lost in the boiler. Moreover, injecting the moisturizer in this manner achieves better steam/moisturizer mixing and allows an operator to precisely and instantaneously control the amount of moisturizer added to the steam. This produces animal feed with a more uniform size and shape and better consistency.

### BACKGROUND OF THE INVENTION

1. Field of the Invention

The present invention relates to animal feed. More particularly, the invention relates to a method and system for producing animal feed with a more uniform size and shape and better consistency.

2. Description of the Prior Art

Cattle, poultry, and other animals are frequently fed pelletized or flaked feeds formed from various feed ingredients such as alfalfa, corn, Milo, wheat, sunflower seed hulls, and/or a mixture of these and other feed ingredients. The animal feed is typically formed by adding the feed ingredients to a steam chest or a conditioner and simultaneously adding steam to the steam chest or conditioner to saturate the feed ingredients to form a mixture with a consistency suitable for flaking or pelleting or some other desired form. The animal feed may then be cooled and stored or transported to a feed lot, barn, or other destination.

To provide better steam saturation of the grains and better consistency and uniformity of the animal feed, it is known to add a moisturizer or other conditioner to the boiler prior to creating the steam. Unfortunately, some of the moisturizer is lost in the boiler and therefore wasted. Moreover, the boiler does not always produce steam with a uniform amount of moisturizer. For example, steam created at different intervals of operation of the boiler may contain different relative quantities of the moisturizer. This makes it difficult to accurately control the amount of moisturizer added to the grains and therefore often results in inconsistent and poorly formed animal feed.

Accordingly, there is a need for an improved method and system for producing animal feed that overcomes the limitations of the prior art.

### SUMMARY OF THE INVENTION

The present invention solves the above-described problems and provides a distinct advance in the art of animal feed production. More particularly, the present invention provides a method and system for producing animal feed with a more uniform size and shape and better consistency without wasting moisturizer in a boiler.

One embodiment of the present invention is a method of producing animal feed comprising the steps of introducing water into a boiler; boiling the water to create steam; collecting the steam and directing it out of the boiler; injecting a moisturizer, by way of an injection quill, into the steam after the steam has exited the boiler to create a steam/moisturizer mixture; feeding grains into a steam chest; applying the steam/moisturizer mixture to the grains in the steam chest to create a grain mixture; and forming the grain mixture into animal feed pieces of a desired shape and size such as flakes. The animal feed pieces may then be cooled, stored, and/or transported to a final destination. In another embodiment, the feed ingredients are fed into a conditioner rather than a steam chest and then formed into pellets or cubes rather than flakes.

Another embodiment of the present invention is a system for producing animal feed comprising a boiler for boiling water to create steam; a steam chest for mixing the steam with grain; a steam line connecting the boiler to the steam chest; a grain feeder for feeding the grain to the steam chest; an injector positioned in the steam line between the boiler and the steam chest for injecting a moisturizer into the steam after the steam exits the boiler but before the steam enters the steam chest; and a roller mill for forming the grain mixture into animal feed pieces of a desired shape and size such as flakes. In another embodiment, the system includes a conditioner rather than a steam chest and a pellet mill rather than a roller mill for forming the grain mixture into pellets or cubes rather than flakes.

By injecting the moisturizer into the steam after the steam exits the boiler instead of mixing the moisturizer with water introduced into the boiler, none of the moisturizer is lost in the boiler or lost due to skimmer or blowdown. Moreover, injecting the moisturizer in this manner achieves better steam/moisturizer mixing and allows an operator to precisely and instantaneously control the amount of moisturizer added to the steam. Application of the moisturizer in this manner also reduces the electricity usage of the feed forming components such as the roller mill and pellet mill and increases the production rates of these components. The invention also permits the use of higher steam pressure and temperature; decreases the amount of labor necessary to create a given amount of animal feed; increases the pellet mill and roller mill life; and improves the overall operations of the animal feed production system. Finally, the invention produces animal feed with a more uniform size and shape and better consistency.

These and other important aspects of the present invention are described more fully in the detailed description below.

### BRIEF DESCRIPTION OF THE DRAWING FIGURES

A preferred embodiment of the present invention is described in detail below with reference to the attached drawing figures, wherein:

FIG. 1 is a schematic diagram of an animal feed production system constructed in accordance with a preferred embodiment of the present invention.

FIG. 2 is a schematic diagram of an animal feed production system constructed in accordance with another preferred embodiment of the present invention.

The drawing figures do not limit the present invention to the specific embodiments disclosed and described herein. The drawings are not necessarily to scale, emphasis instead being placed upon clearly illustrating the principles of the invention.

### DETAILED DESCRIPTION OF THE PREFERRED EMBODIMENTS

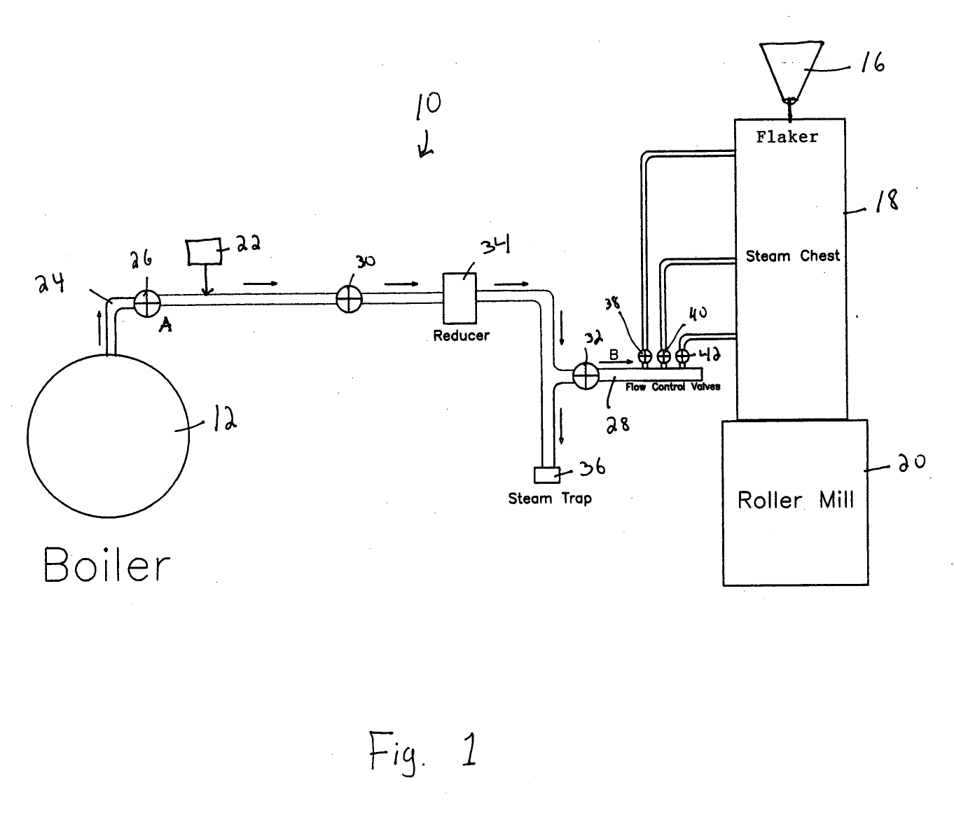

Turning now to the drawing figures, and particularly FIG. 1, an animal feed production system 10 constructed in accordance with a preferred embodiment of the invention is illustrated. The system 10 is illustrated and described herein for purposes of disclosing a best mode of implementing the methods of the present invention. The system 10, and the individual components thereof, may be replaced with other similar systems and components without departing from the scope of the claims set forth in this application.

The system 10 broadly comprises a boiler 12; a grain feeder 16; a steam chest 18; a roller mill 20; and an injector 22. These components themselves are conventional; the novelty of the present invention being the combination, operation, and/or placement of the components as described herein.

The boiler 12 is provided for boiling water and creating steam. The boiler 12 may be connected to one or more water pipes, one or more pumps, and/or a feedwater tank for providing water to the boiler and a drain for draining water from the boiler. At least one pipe 24 or steam line is connected to the top of the boiler 12 to collect and carry steam from the boiler. A steam header may be connected to the boiler 12 by the pipe 24 or other pipes or steam lines. A shut-off valve 26 may be interposed in the pipe 24 exiting the boiler 12 so that the flow of steam from the boiler 12 can be selectively interrupted for maintenance, operational, or other purposes.

The grain feeder 16 feeds or otherwise delivers grain such as alfalfa, corn, Milo, wheat, sunflower seed hulls, and/or a mixture of these and other feed ingredients into the steam chest 18. The grain feeder 16 may deliver the grain into the steam chest via a gravity feed mechanism, a conveyor, or any other conventional delivery means.

The steam chest 18 is connected to the boiler 12 via the pipe 24 or one or more other pipes 28 or other steam lines. The pipes 24, 28 and any connecting pipes are sometimes collectively referred to herein as “steam line”. The steam chest 18 mixes or otherwise combines the steam from the boiler 12 with the grain delivered from the grain feeder 16.

One or more valves may be positioned in the steam line between the boiler 12 and the steam chest 18 for a variety of purposes. For example, a directional valve 30 may be positioned downstream of the boiler 12 to direct steam to the steam chest 18 and/or other steam chests that are not illustrated. Another valve 32 may be positioned immediately upstream of the steam chest 18 to disrupt the flow of steam to the steam chest 18 for maintenance, operational, or other purposes.

A steam reducer 34 or regulator may also be positioned in the steam line between the boiler 12 and the steam chest 18 to regulate the flow of steam to the steam chest 18. The steam reducer 34 may, for example, provide steam at a constant pressure of 60 psi to the steam chest 18.

A steam trap 36 may also be connected between the steam line and the boiler 12 to serve as a condensate return. A number of flow control valves 38,40,42 and associated pipes may be connected to the input of the steam chest 18 to provide several points of entry for the steam into the steam chest 18. Of course, any number of steam input points can be provided in the steam chest 18.

The roller mill 20 receives the steam and grain mixture from the steam chest 18 and includes one or more rollers or other mechanisms for forming the mixture into individual pieces of animal feed of a desired shape and size. In the embodiment shown in FIG. 1, the roller mill produces a flaked animal feed product. The roller mill 20 may be connected to a cooling unit for cooling the animal feed pieces and a conveyor or other transport mechanism for transporting the finished animal feed to a truck, bin, or other storage device.

The injector 22 is provided for injecting a moisturizer into the steam created by the boiler 12. An example of a moisturizer that may be used with the present invention is manufactured by BASF under the trade name Pluracol®. The injector 22 may be any conventional mechanism used to inject fluids, gases, or other compounds into a steam line such as an injector quill.

In accordance with one important aspect of the present invention, the injector 22 injects the moisturizer into the steam after it exits the boiler 12. The injector is preferably positioned somewhere in the steam line between the boiler 12 and the steam chest 18. Specifically, the injector 22 may be positioned anywhere between the points denoted as A and B in FIG. 1. For example, the injector 22 may be positioned to inject moisturizer into the steam immediately after it exits the boiler 12, before it passes through the reducer 34, after it passes through the reducer 34, or immediately before it enters the steam chest 18.

The animal feed production system 10 operates as follows. Water is first introduced into the boiler 12 and then boiled to create steam. The steam is collected and directed out of the boiler 12 and may be directed to a steam header. Moisturizer is then injected into the steam by the injector 22 after the steam has exited the boiler 12 to create a steam/moisturizer mixture. The moisturizer is preferably injected into the steam at a rate between 1 and 3 ounces of moisturizer per ton of grain.

Grain or other feed ingredients are fed into the steam chest 18 by the grain feeder 16. The steam/moisturizer mixture is then mixed with or otherwise combined with the grain in the steam chest 18 to form a grain mixture. After the grain has been exposed to the steam, the grain mixture is fed to the roller mill 20 where it is formed into animal feed pieces having a desired shape and size. As discussed above, the system 10 preferably creates flaked animal feed. The animal feed pieces may then be cooled, stored, and/or transported to a final destination.

By injecting the moisturizer into the steam after the steam has exited the boiler instead of mixing the moisturizer with water introduced into the boiler, none of the moisturizer is lost in the boiler or lost due to skimmer or blowdown. Moreover, injecting the moisturizer in this manner achieves better steam/moisturizer mixing and allows an operator to precisely and instantaneously control the amount of moisturizer added to the steam. Application of the moisturizer in this manner also reduces the electricity usage of the feed forming components and increases the production rates of these components. The present invention also permits the use of higher steam pressure and temperature; decreases the amount of labor necessary to create a given amount of animal feed; increases pellet mill and roller mill life; and improves the overall operations of an animal feed production system. Finally, the invention produces animal feed with a more uniform size and shape and better consistency.

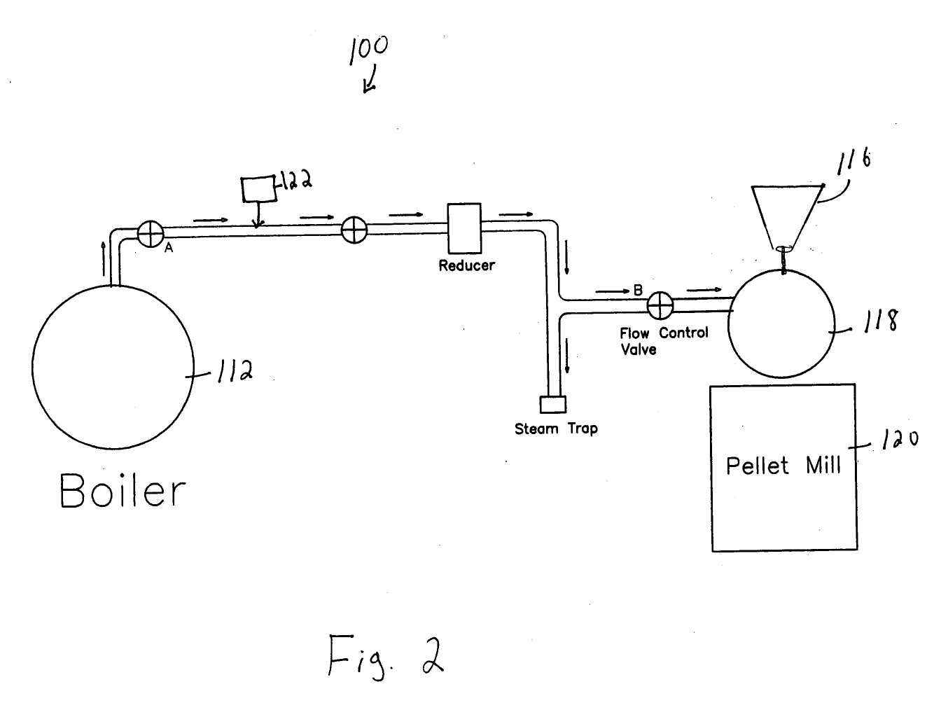

FIG. 2 illustrates an animal feed production system 100 constructed in accordance with another embodiment of the invention. The system 100 is substantially the same as the system 10 and includes a boiler 112, a grain feeder 116, an injector 122, a conditioner 118 rather than a steam chest, and a pellet mill 120 rather than a roller mill. The conditioner 118 mixes the grain and steam with paddles. The pellet mill 120 includes a number of rollers and an iron mold extruder for extruding the grain and steam mixture into a desired shape and size of animal feed such as individual pellets or cubes. The operation of the system 100 is the same as the system 10 except that the system 100 creates pelleted animal feed. Flaked and pelleted feed are only two examples of animal feed that may be produced with the present invention.

Although the invention has been described with reference to the preferred embodiment illustrated in the attached drawing figures, it is noted that equivalents may be employed and substitutions made herein without departing from the scope of the invention as recited in the claims. For example, the particular systems 10,100 and the components thereof for implementing the method of the present invention may be replaced with other systems and components without departing from the scope of the present invention. Similarly, the method steps described above do not necessarily have to be performed in the order they are presented in the application.

Having thus described the preferred embodiment of the invention, what is claimed as new and desired to be protected by Letters Patent includes the following:

1. A method of producing animal feed comprising the steps:
introducing water into a boiler;
boiling the water to create steam;
collecting the steam and directing it out of the boiler;
injecting a moisturizer into the steam after the steam has exited the boiler to create a steam/moisturizer mixture;
feeding grains into a steam chest;
applying the steam/moisturizer mixture to the grains in the steam chest to create a grain mixture; and
forming the grain mixture into animal feed pieces of a desired shape and size.

2. The method as set forth in claim 1, further including the step of cooling the animal feed pieces after they have been formed.

3. The method as set forth in claim 1, wherein the moisturizer is injected into a steam line connected to the boiler via an injection quill.

4. The method as set forth in claim 1, wherein the forming step includes the step of rolling the grain mixture to form flaked animal feed pieces.

5. The method as set forth in claim 1, wherein the forming step includes the step of extruding the grain mixture to form pelleted or cubed animal feed pieces.

6. The method as set forth in claim 1, further including the step of regulating the steam with a steam reducer to provide a relatively constant flow of steam into the steam chest.

7. The method as set forth in claim 6, wherein the moisturizer is injected into the steam after the steam has been regulated by the steam reducer.

8. The method as set forth in claim 6, wherein the moisturizer is injected into the steam before the steam has been regulated by the steam reducer.

9. The method as set forth in claim 1, wherein the steam passes from the boiler to a steam header and wherein the moisturizer is injected into the steam after the steam exits the steam header.

10. The method as set forth in claim 1, further including the step of controlling flow of the steam/moisturizer mixture into the steam chest with at least one steam flow control valve, wherein the moisturizer is injected into the steam before the steam passes through the steam flow control valve.

11. A system for producing animal feed comprising:
a boiler for boiling water to create steam;
a steam chest connected to the boiler with a steam line;
a grain feeder for feeding grain to the steam chest; and
an injector positioned in the steam line between the boiler and the steam chest for injecting a moisturizer into the steam after the steam exits the boiler but before the steam enters the steam chest.

12. The system as set forth in claim 11, wherein the injector is an injection quill.

13. The system as set forth in claim 11, wherein the moisturizer and the steam mixes with the grain in the steam chest to form a grain mixture, further including a mill for forming the grain mixture into animal pieces of a desired shape and size.

14. The system as set forth in claim 11, further including a unit for cooling the animal pieces.

15. A system for producing animal feed comprising:
a boiler for boiling water to create steam;
a conditioner connected to the boiler with a steam line;
a grain feeder for feeding grain to the conditioner; and
an injector positioned in the steam line between the boiler and the conditioner for injecting a moisturizer into the steam after the steam exits the boiler but before the steam enters the conditioner.

16. The system as set forth in claim 15, wherein the injector is an injection quill.
